(19) United States
(12) Patent Application Publication
(10) Pub. No.: US 2025/0097063 A1
(43) Pub. Date: Mar. 20, 2025

(54) INFORMATION PRESENTATION METHOD, INFORMATION PRESENTATION DEVICE, AND INFORMATION PRESENTATION PROGRAM

(71) Applicant: NIPPON TELEGRAPH AND TELEPHONE CORPORATION, Tokyo (JP)

(72) Inventors: Mitsuhiro GOTO, Musashino-shi, Tokyo (JP); Hitoshi SESHIMO, Musashino-shi, Tokyo (JP)

(73) Assignee: NIPPON TELEGRAPH AND TELEPHONE CORPORATION, Tokyo (JP)

(21) Appl. No.: 18/576,107

(22) PCT Filed: Jul. 5, 2021
(86) PCT No.: PCT/JP2021/025341

§ 371 Date: Jan. 3, 2024

(51) Int. Cl. H04L 12/18; G06T 13/80

(52) U.S. Cl. CPC H04L 12/1822; G06T 13/80

(57) ABSTRACT

An information presentation method for presenting action instruction information to a presentation proxy device that performs a presentation as proxy includes: a step of acquiring a scenario of a presentation and data of a personality characteristic of a human presenter; a step of converting the scenario by using an action characteristic model in accordance with the data of the personality characteristic of the human presenter; and a step of outputting the scenario converted, to the presentation proxy device.

### TECHNICAL FIELD

An embodiment of the present invention relates to an information presentation method, an information presentation device, and an information presentation program.

### BACKGROUND ART

Presentation is important in one-use-case exhibition or meeting of digital workers. In recent years, a technology related to a presentation proxy device that executes a presentation on behalf of a person has been proposed, and there is a large demand for such a presentation proxy device and the like.

Patent Literature 1 discloses a technology for generating instruction information on an action to be executed by a presentation proxy device. In this technology, a presentation executed by an actual human presenter is recorded, and a presentation proxy device is caused to reproduce a representative motion from the recorded content, whereby the presentation is performed as proxy. Reproduction of the representative motion is likely to be uniform reproduction, and there is a possibility that an appeal effect is reduced due to habituation of an audience.

Non Patent Literature 1 proposes that a characteristic action is given to an action of the presentation proxy device by using a GUI tool. However, it requires a very complicated work to give all the characteristic actions.

Non Patent Literature 2 asserts that a complex motion capture device is required for highly accurate action reproduction. However, it requires a lot of cost to realize the characteristic action by reproduction of an action of the person.

### CITATION LIST

### Patent Literature

Patent Literature 1: JP 2019-144732 A

### NON PATENT LITERATURE

### Non Patent Literature 1: E. Pot, J. Monceaux, R. Gelin, B. Maisonnier, “Choregraphe: a Graphical Tool for Humanoid Robot Programming”, Robot and Human Interactive Communication, 2009, pp. 46-51

Non Patent Literature 2: G. Kaiwan et al., “Effects of Virtual-Avatar Motion-Synchrony Levels on Full-Body Interaction”, ACM SAC '19, 2019

### SUMMARY OF INVENTION

### Technical Problem

The present invention has been made in view of the above circumstances, and an object of the present invention is to provide an information presentation method, an information presentation device, and an information presentation program that cause a presentation proxy device to execute a characteristic action that breaks away from reproduction of a uniform action at a low cost.

### Solution to Problem

An information presentation method according to an aspect of the present invention is a method for presenting action instruction information to a presentation proxy device, and includes: a step of acquiring a scenario of a presentation and data of a personality characteristic of a human presenter; a step of converting the scenario by using an action characteristic model in accordance with the data of the personality characteristic of the human presenter; and a step of outputting the scenario converted, to the presentation proxy device.

An information presentation device according to an aspect of the present invention is a device that presents action instruction information to a presentation proxy device, the device including: a data acquisition unit that acquires a scenario of a presentation and data of a personality characteristic of a human presenter; a scenario conversion unit that converts the scenario by using an action characteristic model in accordance with the data of the personality characteristic of the human presenter; and a data output unit that outputs the scenario converted, to the presentation proxy device.

An information presentation program according to an aspect of the present invention causes a computer to execute processing of the information presentation method.

### Advantageous Effects of Invention

According to the present invention, there are provided an information presentation method, an information presentation device, and an information presentation program that cause a presentation proxy device to execute a characteristic action that breaks away from reproduction of a uniform action at a low cost.

### BRIEF DESCRIPTION OF DRAWINGS

FIG. 1 is a block diagram illustrating a configuration of a system including an information presentation device according to an embodiment.

FIG. 2 is a block diagram illustrating a hardware configuration of the information presentation device according to the embodiment.

FIG. 3 is a schematic diagram illustrating an example of a proxy device illustrated in FIG. 1.

FIG. 4 is a schematic diagram illustrating another example of the proxy device illustrated in FIG. 1.

FIG. 5 is a schematic diagram illustrating an example of data regarding a personality characteristic axis and a priority order stored in a characteristic comparison storage unit illustrated in FIG. 1 in a tabular format.

FIG. 6 is a schematic diagram illustrating an example of data of an action characteristic model stored in an individual action storage unit illustrated in FIG. 1 in a tabular format.

FIG. 7 is a schematic diagram illustrating an example of a relationship among Bigfive indexes, actions of various action categories, and elements of action parameters in construction of the action characteristic model.

FIG. 8 is a flowchart illustrating overall operation of the information presentation device illustrated in FIG. 1.

FIG. 9 is a flowchart illustrating an operation of determining a personality characteristic of a human presenter in the information presentation device illustrated in FIG. 1.

FIG. 10 is a flowchart illustrating details of an operation of correcting an action in a scenario in the information presentation device illustrated in FIG. 1.

FIG. 11 is a flowchart illustrating details of an operation of adding an action in the scenario in the information presentation device illustrated in FIG. 1.

### DESCRIPTION OF EMBODIMENTS

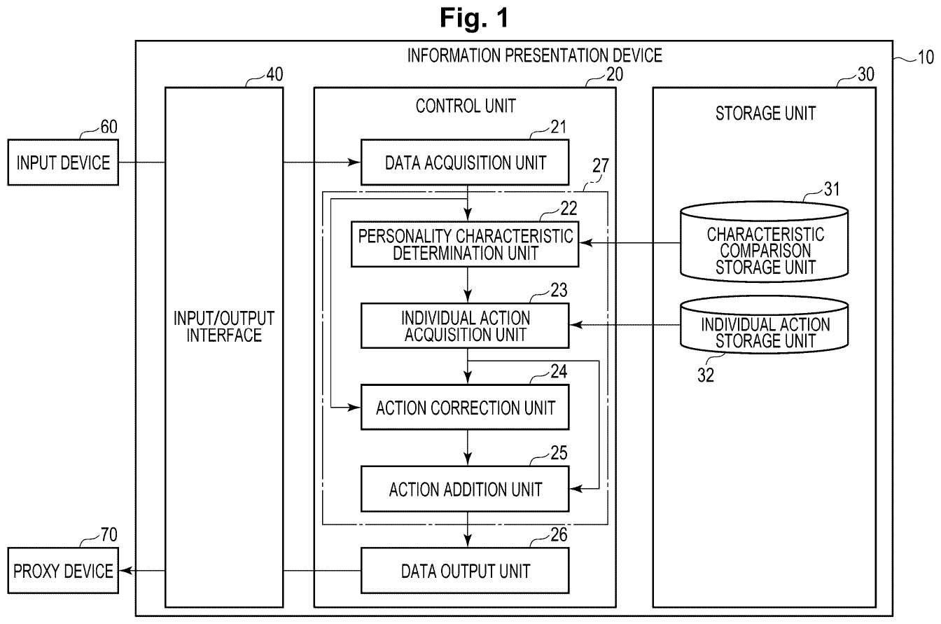

Hereinafter, an embodiment of the present invention will be described with reference to the drawings. First, a system including an information presentation device according to the embodiment will be described with reference to FIGS. 1 to 7.

### (1-1) System Configuration

FIG. 1 is a block diagram illustrating a configuration of the system including the information presentation device according to the embodiment. This system converts a scenario of a presentation and executes the presentation in accordance with the converted scenario.

The system includes an information presentation device 10, an input device 60, and a presentation proxy device 70. In FIG. 1, the presentation proxy device 70 is abbreviated as a proxy device 70. In addition, in the following description, the presentation proxy device 70 is simply referred to as the proxy device 70.

The input device 60 is a device for inputting the scenario of the presentation to the information presentation device 10. The scenario includes data such as a slide, an image, a gesture, an utterance content, a text of an utterance content, and a switching timing of slides or images. In general, the scenario includes a plurality of slides, and includes data of utterance content and non-verbal action for each slide.

The information presentation device 10 is a device that receives the scenario of the presentation from the input device 60, converts the scenario, and outputs the converted scenario to the proxy device 70.

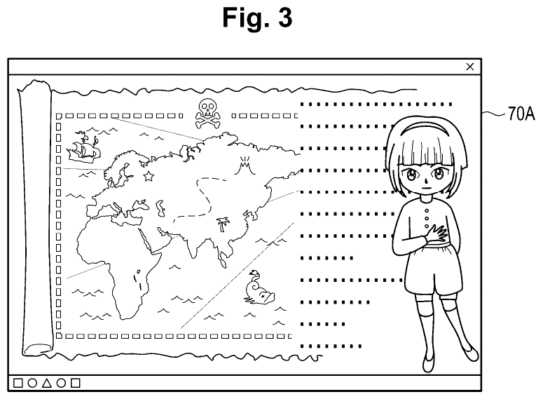

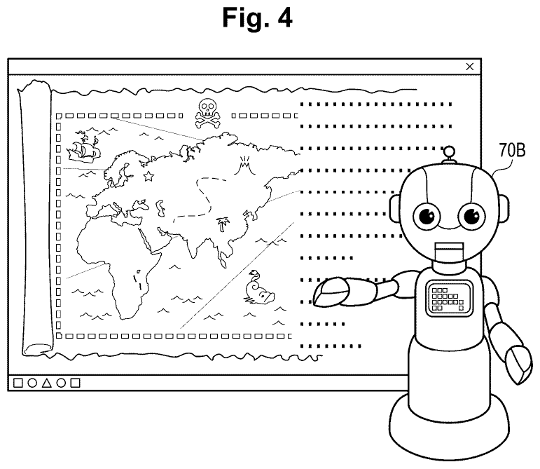

The proxy device 70 is a device that executes the presentation in accordance with the scenario provided from the information presentation device 10. The proxy device 70 may be any device, system, or the like as long as it can express three elements of an oral content, a slide content, and a gesture action. FIG. 3 illustrates a virtual agent 70A that executes a presentation in a virtual space as an example. In addition, FIG. 4 illustrates a robot 70B that executes a presentation in a real space as another example.

### (1-2) Functional Configuration of Information Presentation Device 10

Next, a functional configuration of the information presentation device 10 will be described. The information presentation device 10 includes, for example, a computer. As illustrated in FIG. 1, the information presentation device 10 includes a control unit 20, a storage unit 30, and an input/output interface 40.

The control unit 20 executes various operations necessary for the information presentation device 10. In brief, the control unit 20 executes an operation of acquiring data of the scenario, an operation of converting the acquired scenario, and an operation of outputting the converted scenario.

The storage unit 30 stores various data necessary for the operation of the control unit 20.

The input/output interface 40 inputs and outputs data between the control unit 20, and the input device 60 and the proxy device 70. Specifically, the input/output interface 40 inputs data of the scenario input from the input device 60 to the control unit 20. The input/output interface 40 also outputs data of the scenario output from the control unit 20 to the proxy device 70.

The control unit 20 includes, as functional components, a data acquisition unit 21, a personality characteristic determination unit 22, an individual action acquisition unit 23, an action correction unit 24, an action addition unit 25, and a data output unit 26. The storage unit 30 includes a characteristic comparison storage unit 31 and an individual action storage unit 32, as functional components.

The data acquisition unit 21 acquires data from the input device 60 via the input/output interface 40. The data acquired by the data acquisition unit 21 includes data of the scenario and data of a personality characteristic of a human presenter in the scenario. Hereinafter, for convenience, the data of the scenario and the data of the personality characteristic are also referred to as scenario data and personality characteristic data, respectively.

The personality characteristic data includes a plurality of indexes related to an individuality of a person and a score in each index. An example of the plurality of indexes is Bigfive (big five). Bigfive (big five) includes five indexes, Openness (openness), Conscientiousness (honesty), Extraversion (extroversion), Agreeableness (cooperativeness), and Neuroticism (neuroticism).

Hereinafter, for convenience, Bigfive (big five), Openness (openness), Conscientiousness (honesty), Extraversion (extroversion), Agreeableness (cooperativeness), and Neuroticism (neuroticism) are simply referred to as Bigfive, Openness, Conscientiousness,

Extraversion, Agreeableness, and Neuroticism, respectively. In addition, an index in the personality characteristic data is also referred to as a personality characteristic axis or simply an axis.

Here, Bigfive is mentioned as an example of the plurality of indexes related to the individuality of the person, but the personality characteristic data may include an index capable of classifying personalities, such as an Enneagram diagnosis, in addition to Bigfive.

The data acquisition unit 21 supplies the data of the scenario to the action correction unit 24 and the action addition unit 25, and supplies the personality characteristic data of the human presenter to the personality characteristic determination unit 22.

The personality characteristic determination unit 22 determines the personality characteristic of the human presenter. Specifically, the personality characteristic determination unit 22 determines the personality characteristic of the human presenter on the basis of the personality characteristic data of the human presenter supplied from the data acquisition unit 21. In the determination of the personality characteristic, the personality characteristic determination unit 22 refers to a rule stored in the characteristic comparison storage unit 31 if necessary.

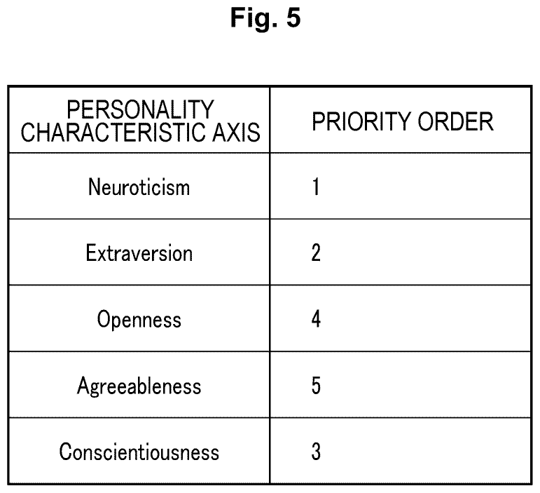

For example, the rule stored in the characteristic comparison storage unit 31 includes data indicating a relationship between the personality characteristic axes of Bigfive and priority orders of the personality characteristic axes. FIG. 5 is a schematic diagram illustrating the stored rule indicating the relationship between the personality characteristic axes and the priority orders, in a tabular format. Hereinafter, the rule indicating the relationship between the personality characteristic axes and the priority orders is referred to as a priority rule, for convenience.

The personality characteristic determination unit 22 supplies a result of determination of the personality characteristic of the human presenter to the individual action acquisition unit 23.

The individual action acquisition unit 23 acquires data of an action characteristic model corresponding to the result of determination supplied from the personality characteristic determination unit 22 from the individual action storage unit 32.

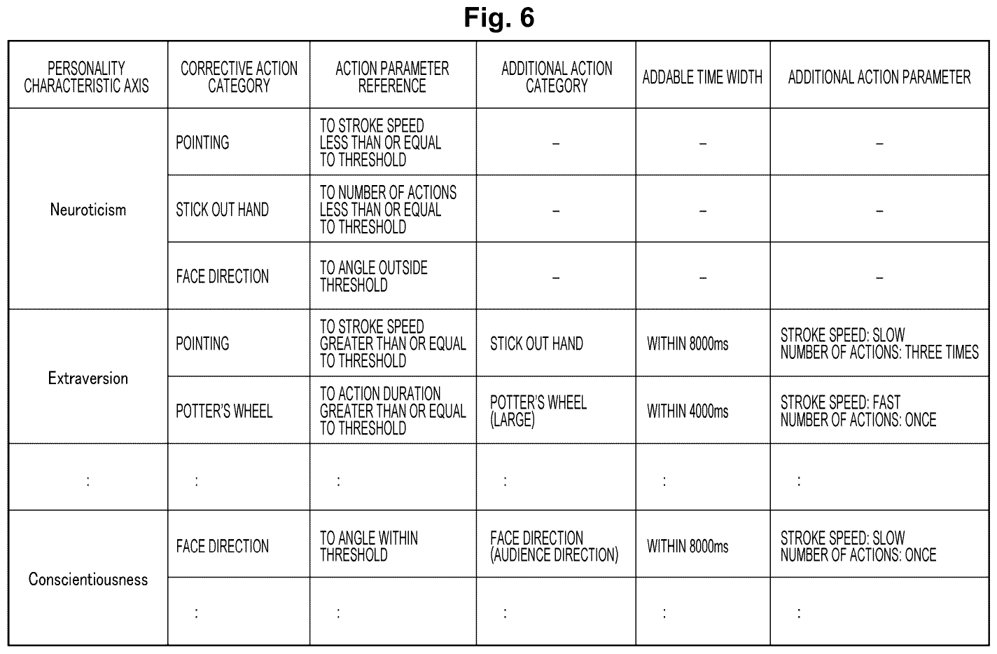

The individual action storage unit 32 stores the data of the action characteristic model. FIG. 6 is a schematic diagram illustrating an example of the data of the action characteristic model stored in the individual action storage unit 32 in a tabular format. The tabular data of the action characteristic model includes items of a personality characteristic axis, a corrective action category, an action parameter reference, an additional action category, an addable time width, and an additional action parameter. The data of the action characteristic model includes data of the corrective action category, the action parameter reference, the additional action category, the addable time width, and the additional action parameter for each personality characteristic axis.

That is, actions of the corrective action category and the additional action category are set corresponding to each personality characteristic axis. In addition, the action parameter reference is set corresponding to each action of the corrective action category. The addable time width and the additional action parameter are set corresponding to each action of the additional action category.

The actions of the corrective action category and the additional action category illustrated in FIG. 6 are examples of representative actions used in presentation, and may have other actions.

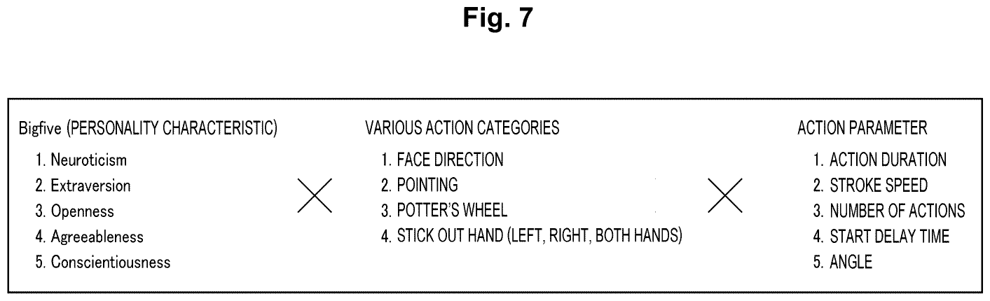

FIG. 7 is a schematic diagram illustrating an example of a relationship among Bigfive indexes, actions of various action categories, and elements of action parameters in construction of the action characteristic model. An action of the various action categories viewed as important is selected for each index of Bigfive, and an action parameter is determined for the selected action, whereby the data of the action characteristic model illustrated in FIG. 6 is constructed.

The individual action acquisition unit 23 supplies the data of the action characteristic model acquired from the individual action storage unit 32 to the action correction unit 24 and the action addition unit 25. Specifically, the individual action acquisition unit 23 supplies data of the corrective action category and the action parameter reference, to the action correction unit 24. In addition, the individual action acquisition unit 23 supplies data of the additional action category, the addable time width, and the additional action parameter, to the action addition unit 25.

The action correction unit 24 appropriately corrects an action in the scenario on the basis of the data of the scenario supplied from the data acquisition unit 21 and the data of the action characteristic model supplied from the individual action acquisition unit 23. That is, the action correction unit 24 may not correct an action in the scenario. In addition, the action correction unit 24 supplies data of the scenario in which the action is corrected, to the action addition unit 25.

The action addition unit 25 appropriately adds an action in the scenario on the basis of the data of the scenario supplied from the data acquisition unit 21 and the data of the action characteristic model supplied from the individual action acquisition unit 23. That is, the action addition unit 25 may not add an action in the scenario. In addition, the action addition unit 25 supplies data of the scenario to which the action is added to the data output unit 26.

The personality characteristic determination unit 22, the individual action acquisition unit 23, the action correction unit 24, and the action addition unit 25 described above constitute a scenario conversion unit 27 that converts the scenario. Here, converting the scenario includes correcting an action in the scenario and/or adding an action in the scenario. In addition, due to the circumstances described above, in some cases, converting the scenario may include not correcting or adding an action.

The data output unit 26 outputs the data of the scenario supplied from the action addition unit 25 to the proxy device 70 via the input/output interface 40. That is, the data output unit 26 outputs the data of the scenario converted (subjected to action correction and/or action addition) by the scenario conversion unit 27 to the proxy device 70 via the input/output interface 40.

### (1-3) Hardware Configuration of Information Presentation Device 10

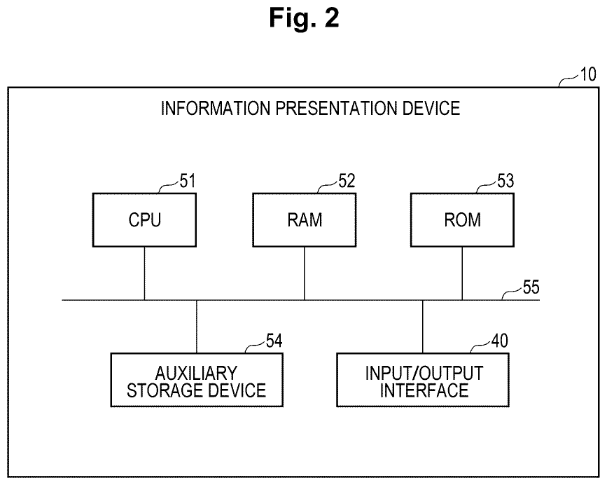

FIG. 2 is a block diagram illustrating an example of a hardware configuration of the information presentation device 10. As described above, the information presentation device 10 includes, for example, a computer. As illustrated in FIG. 2, the information presentation device 10 includes, as a hardware configuration, a central processing unit (CPU) 51, a random access memory (RAM) 52, a read only memory (ROM) 53, an auxiliary storage device 54, and an input/output interface 40. The CPU 51, the RAM 52, the ROM 53, the auxiliary storage device 54, and the input/output interface 40 are electrically connected to each other via a bus 55.

The CPU 51 is an example of a general-purpose hardware processor, and controls overall operation of the information presentation device 10.

The RAM 52 is a main storage device, and includes, for example, a volatile memory such as a synchronous dynamic random access memory (SDRAM). The RAM 52 temporarily stores a program and information necessary for processing executed by the CPU 51.

The ROM 53 non-temporarily stores a program and information necessary for basic processing performed by the CPU 51.

The CPU 51, the RAM 52, and the ROM 53 constitute the control unit 20 of the information presentation device 10.

The auxiliary storage device 54 includes, for example, a non-volatile storage medium such as a hard disk drive (HDD) or a solid state drive (SSD). The auxiliary storage device 54 constitutes the storage unit 30. That is, the auxiliary storage device 54 constitutes the characteristic comparison storage unit 31 and the individual action storage unit 32.

In addition, the auxiliary storage device 54 stores an information presentation program necessary for the operation of the information presentation device 10. The information presentation program is a program that causes the CPU 51 to execute a function of the control unit 20. That is, the information presentation program is a program that causes the CPU 51 to execute functions of the data acquisition unit 21, the personality characteristic determination unit 22, the individual action acquisition unit 23, the action correction unit 24, the action addition unit 25, and the data output unit 26. For example, the information presentation program is recorded in a storage medium such as an optical disk, and is read by the auxiliary storage device 54. Alternatively, the program is stored in a server on a network and downloaded to the auxiliary storage device 54.

The CPU 51 reads the information presentation program from the auxiliary storage device 54 into the RAM 52 and executes the information presentation program, thereby operating as the data acquisition unit 21, the personality characteristic determination unit 22, the individual action acquisition unit 23, the action correction unit 24, the action addition unit 25, and the data output unit 26.

Instead of the CPU 51 and the RAM 52, an integrated circuit such as an application specific integrated circuit (ASIC) or a field-programmable gate array (FPGA) may configure the data acquisition unit 21, the personality characteristic determination unit 22, the individual action acquisition unit 23, the action correction unit 24, the action addition unit 25, and the data output unit 26.

### (2-1) Operation of Information Presentation Device 10

Next, description will be given of the operation of the information presentation device 10 configured as described above. Each operation of the information presentation device 10 is executed by cooperation of the control unit 20, the storage unit 30, and the input/output interface 40. Hereinafter, description will be given focusing on each functional component of the control unit 20.

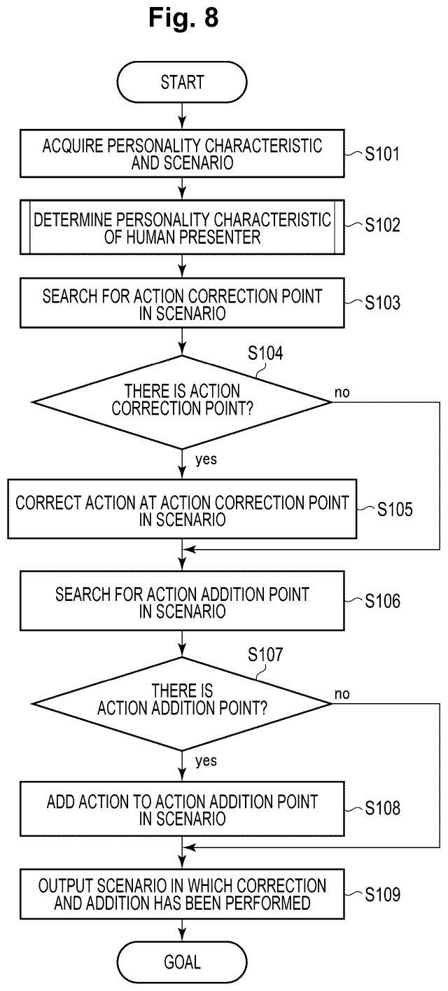

First, overall operation of the information presentation device 10 will be described with reference to FIG. 8. FIG. 8 is a flowchart illustrating the overall operation of the information presentation device 10.

In step S101, the data acquisition unit 21 acquires the personality characteristic data and the scenario data of the human presenter from the input device 60.

In step S102, the personality characteristic determination unit 22 acquires the personality characteristic data of the human presenter from the data acquisition unit 21, and determines the personality characteristic of the human presenter on the basis of the acquired personality characteristic data. In addition, the personality characteristic determination unit 22 further acquires the priority rule from the characteristic comparison storage unit 31 as necessary, and determines the personality characteristic of the human presenter on the basis of the personality characteristic data and the priority rule.

In step S103, the action correction unit 24 acquires the scenario data from the data acquisition unit 21 and analyzes the acquired scenario data to search for an action correction point in the scenario.

In step S104, the action correction unit 24 determines whether or not there is an action correction point in the scenario. In a case where there is an action correction point, that is, in a case where a determination result of step S104 is “yes”, the processing proceeds to step S105. On the other hand, in a case where there is no action correction point, that is, in a case where the determination result of step S104 is “no”, the processing proceeds to step S106.

In step S105, the action correction unit 24 corrects an action at the action correction point in the scenario. When correcting the action, the action correction unit 24 acquires a parameter of a corrective action from the individual action acquisition unit 23, and corrects the action in accordance with the acquired parameter. Details thereof will be described later.

In step S106, the action addition unit 25 acquires the scenario data from the data acquisition unit 21 and analyzes the acquired scenario data to search for an action addition point in the scenario.

In step S107, the action addition unit 25 determines whether or not there is an action addition point in the scenario. In a case where there is an action addition point, that is, in a case where a determination result of step S107 is “yes”, the processing proceeds to step S108. On the other hand, in a case where there is no action correction point, that is, in a case where the determination result of step S107 is “no”, the processing proceeds to step S109.

In step S108, the action addition unit 25 adds an action to the action addition point in the scenario. When adding the action, the action addition unit 25 acquires an additional action and a parameter thereof from the individual action acquisition unit 23, and adds the action in accordance with the acquired additional action and the parameter thereof. Details thereof will be described later.

In step S109, the data output unit 26 outputs the scenario data converted (corrected/added) through the processing from step S101 to step S108 to the proxy device 70.

### (2-2) Personality Characteristic Determination Operation

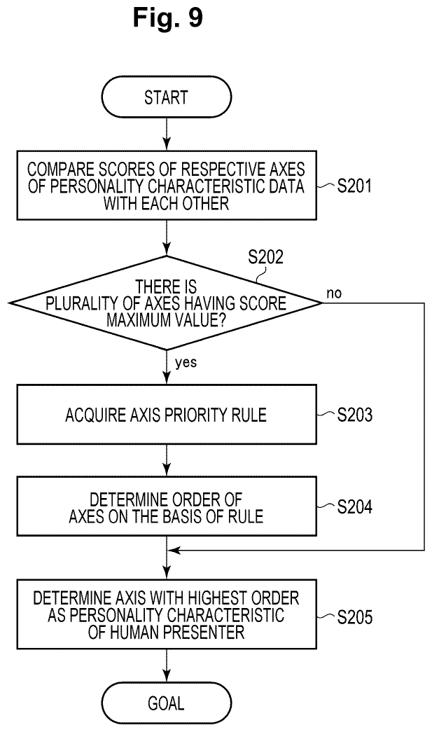

Next, the processing of step S102, that is, an operation of determining the personality characteristic of the human presenter will be described with reference to FIG. 9. FIG. 9 is a flowchart illustrating the operation of determining the personality characteristic of the human presenter.

In step S201, the personality characteristic determination unit 22 compares scores of the respective axes of the personality characteristic data acquired from the data acquisition unit 21 with each other. For example, as described above, the axes of the personality characteristic data are Openness, Conscientiousness, Extraversion, Agreeableness, and Neuroticism in Bigfive.

In step S202, the personality characteristic determination unit 22 determines whether or not there is a plurality of axes having a score maximum value. In a case where there is the plurality of axes, that is, in a case where a determination result of step S202 is “yes”, the processing proceeds to step S203. On the other hand, in a case where there is not the plurality of axes, that is, in a case where the determination result of step S202 is “no”, an axis with the highest order is determined as the axis having the score maximum value, and the processing proceeds to step S205.

In step S203, the personality characteristic determination unit 22 acquires the priority rule described with reference to FIG. 5 from the characteristic comparison storage unit 31.

In step S204, the personality characteristic determination unit 22 determines the order of the plurality of axes on the basis of the acquired priority rule. In step S205, an axis with the highest order is determined as the personality characteristic of the human presenter.

### (2-3) Detailed Operation of Operation Correction

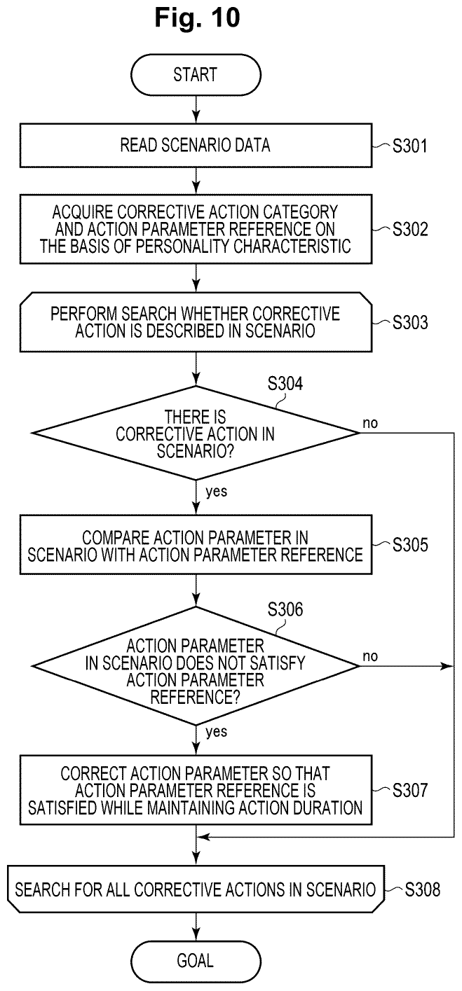

Next, details of the processing from step S103 to step S105, that is, details of an operation of correcting the operation in the scenario will be described with reference to FIG. 10. FIG. 10 is a flowchart illustrating details of the operation of correcting the operation in the scenario.

In step S301, the action correction unit 24 reads the scenario data from the data acquisition unit 21.

In step S302, the individual action acquisition unit 23 acquires the result of determination of the personality characteristic of the human presenter from the personality characteristic determination unit 22. The individual action acquisition unit 23 also acquires data of a corrective action of the action characteristic model corresponding to the result of determination of the personality characteristic from the individual action storage unit 32. As described with reference to FIG. 6, the result of determination of the personality characteristic indicates a personality characteristic axis, and the data of the corrective action includes a corrective action included in a corrective action category corresponding to the personality characteristic axis and an action parameter reference corresponding to each corrective action. That is, the action parameter reference is set for each corrective action of the corrective action category.

In step S303, the action correction unit 24 reads the corrective action and the action parameter reference acquired by the individual action acquisition unit 23 from the individual action acquisition unit 23. Subsequently, the action correction unit 24 performs a search of whether the corrective action is described in the scenario.

In step S304, the action correction unit 24 determines whether or not there is the corrective action in the scenario. In a case where there is the corrective action, that is, in a case where a determination result of step S304 is “yes”, the processing proceeds to step S305. On the other hand, in a case where there is not the corrective action, that is, in a case where the determination result of step S304 is “no”, the processing proceeds to step S308.

In step S305, the action correction unit 24 compares an action parameter of the corrective action in the scenario with an action parameter reference corresponding to the corrective action.

In step S306, the action correction unit 24 determines whether or not the action parameter of the corrective action in the scenario does not satisfy the action parameter reference. In a case where the action parameter does not satisfy the action parameter reference, that is, in a case where a determination result of step S306 is “yes”, the processing proceeds to step S307. On the other hand, in a case where the action parameter satisfies the action parameter reference, that is, in a case where the determination result of step S306 is “no”, the processing proceeds to step S308.

In step S307, the action correction unit 24 corrects the action parameter of the corrective action in the scenario so that the action parameter reference is satisfied while maintaining an action duration. However, in a case where the action parameter reference relates to the action duration, the action duration of the corrective action is corrected.

In step S308, the action correction unit 24 searches for all the corrective actions in the scenario. That is, the action correction unit 24 returns to step S303 and repeats the processing from step S304 to step S307 until the search for all the corrective actions in the scenario is completed.

### (2-4) Detailed Operation of Action Addition

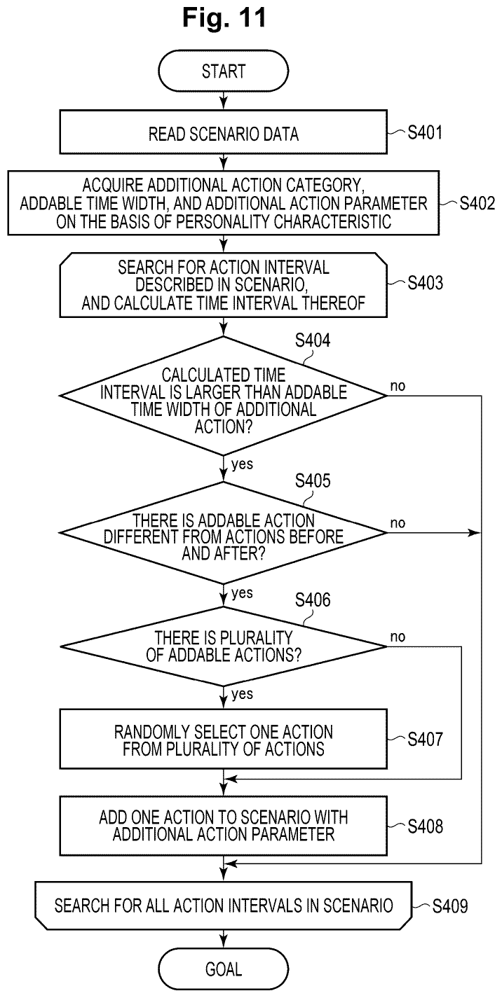

Next, details of the processing from step S106 to step S108, that is, details of an operation of adding the action in the scenario will be described with reference to FIG. 11. FIG. 11 is a flowchart illustrating details of the operation of adding the action in the scenario.

In step S401, the action addition unit 25 reads the scenario data from the action correction unit 24. That is, the scenario data read by the action addition unit 25 reflects the correction by the action correction unit 24.

In step S402, the individual action acquisition unit 23 acquires, from the individual action storage unit 32, data of an additional action of the action characteristic model corresponding to the result of determination of the personality characteristic of the human presenter acquired from the personality characteristic determination unit 22 in step S302. As described with reference to FIG. 6, the result of determination of the personality characteristic indicates a personality characteristic axis, and the data of the additional action includes an additional action included in an additional action category corresponding to the personality characteristic axis, and an addable time width and an additional action parameter corresponding to each additional action. That is, the addable time width and the additional action parameter are set for each additional action of the additional action category.

In step S403, the action addition unit 25 searches for an action interval described in the scenario and calculates a time interval of the action interval.

In step S404, the action addition unit 25 determines whether or not the calculated time interval is larger than the addable time width of the additional action. In a case where the time interval is larger than the addable time width, that is, in a case where a determination result of step S404 is “yes”, the processing proceeds to step S405. On the other hand, in a case where the time interval is not larger than the addable time width, that is, in a case where the determination result of step S404 is “no”, the processing proceeds to step S409.

In step S405, the action addition unit 25 determines whether or not there is an addable action different from actions before and after the time interval larger than the addable time width. In a case where there is the addable action, that is, in a case where a determination result of step S405 is “yes”, the processing proceeds to step S406. On the other hand, in a case where there is not the addable action, that is, in a case where the determination result of step S405 is “no”, the processing proceeds to step S409.

In step S406, the action addition unit 25 determines whether or not there is a plurality of the addable actions. In a case where there is the plurality of addable actions, that is, in a case where a determination result of step S406 is “yes”, the processing proceeds to step S407. On the other hand, in a case where there is not the plurality of addable actions, that is, in a case where the determination result of step S406 is “no”, the addable action is determined as one action to be added in the scenario, and the processing proceeds to step S408.

In step S407, the action addition unit 25 randomly selects one addable action from the plurality of addable actions, and determines the selected addable action as one action to be added in the scenario.

In step S408, the action addition unit 25 adds the addable action determined as one action to be added in the scenario to the scenario with an additional action parameter corresponding to the addable action. An addition position of the addable action is within the action interval found in step S403.

In step S409, the action addition unit 25 searches for all action intervals in the scenario. That is, the action addition unit 25 returns to step S403 and repeats the processing from step S404 to step S408 until the search for all action intervals in the scenario is completed.

### (3) Effects

As described above, the information presentation device 10 according to the embodiment acquires a scenario of a presentation and data of a personality characteristic of a human presenter, converts the scenario by using an action characteristic model in accordance with the data of the personality characteristic of the human presenter, and outputs the converted scenario to the proxy device 70. As a result, it is possible to create a scenario including a characteristic action that breaks away from reproduction of a uniform action at a low cost. In addition, since the proxy device 70 executes a presentation that breaks away from the uniform reproduction, it is possible to avoid a decrease in an appeal effect due to habituation of an audience. Since the scenario is converted in accordance with the personality characteristic of the human presenter, it is possible to cause the proxy device 70 to execute the presentation without unnaturalness.

Thus, according to the embodiment, there are provided an information presentation method, an information presentation device, and an information presentation program that cause a presentation proxy device to execute a characteristic action that breaks away from reproduction of a uniform action at a low cost.

Note that the present invention is not limited to the above-described embodiment, and various modifications can be made at the implementation stage without departing from the gist of the invention. In addition, embodiments may be implemented in an appropriate combination, and in that case, a combined effect is obtained. Furthermore, the embodiments described above include various inventions, and various inventions can be extracted by a combination selected from a plurality of disclosed components. For example, even if some components are eliminated from all the components described in the embodiments, in a case where the problem can be solved and the advantageous effects can be obtained, a configuration from which the components are eliminated can be extracted as an invention.

### REFERENCE SIGNS LIST

10 information presentation device
20 control unit
21 data acquisition unit
22 personality characteristic determination unit
23 individual action acquisition unit
24 action correction unit
25 action addition unit
26 data output unit
27 scenario conversion unit
30 storage unit
31 characteristic comparison storage unit
32 individual action storage unit
40 input/output interface
51 CPU
52 RAM
53 ROM
54 auxiliary storage device
55 bus
60 input device
70 presentation proxy device
70A virtual agent
70B robot

1. An information presentation method, comprising:
acquiring a scenario of a presentation and data of a personality characteristic of a human presenter;
converting the scenario by using an action characteristic model in accordance with the data of the personality characteristic of the human presenter; and
outputting the scenario which has been converted.

2. The information presentation method according to claim 1, wherein the step of converting the scenario includes:
comparing scores of the data of the personality characteristic of the human presenter in axes of a plurality of factors of the action characteristic model with each other;
determining an axis having a score maximum value; and
determining the axis having the score maximum value as the personality characteristic of the human presenter.

3. The information presentation method according to claim 2, wherein;
the converting the scenario includes correcting an action in the scenario on a basis of the personality characteristic of the human presenter which has been acquired.

4. The information presentation method according to claim 3, wherein the correcting the action includes:
acquiring a corrective action category and an action parameter reference of the action characteristic model corresponding to the personality characteristic of the human presenter determined;
finding an action correction point in the scenario on a basis of a corrective action included in the corrective action category;
comparing an action parameter of the corrective action at the action correction point which has been found with the action parameter reference; and
correcting the corrective action having the action parameter that does not satisfy the action parameter reference such that the action parameter reference is satisfied.

5. The information presentation method according to claim 2, wherein;
the step of converting the scenario includes adding an action in the scenario on a basis of the personality characteristic of the human presenter which was determined.

6. The information presentation method according to claim 5, wherein the step of adding the action includes:
acquiring an additional action category, an addable time width, and an additional action parameter in the action characteristic model corresponding to the personality characteristic of the human presenter that has been determined;
finding an action addition point in the scenario on a basis of the addable time width and an additional action included in the additional action category; and
adding the additional action with the additional action parameter to the action addition point found.

7. An information presentation device, comprising:
data acquisition circuitry configured to acquire a scenario of a presentation and data of a personality characteristic of a human presenter;
scenario conversion circuitry configured to convert the scenario by using an action characteristic model in accordance with the data of the personality characteristic of the human presenter; and
data output circuitry configured to output the scenario converted, to a presentation proxy device.

8. A non-transitory computer readable medium storing a information presentation program for causing a computer to execute processing of the information presentation method according to claim 1.

9. The information presentation device according to claim 7, wherein the scenario conversion circuitry includes:
circuitry configured to compare scores of the data of the personality characteristic of the human presenter in axes of a plurality of factors of the action characteristic model with each other;
circuitry configured to determine an axis having a score maximum value; and
circuitry configured to determine the axis having the score maximum value as the personality characteristic of the human presenter.

10. The information presentation device according to claim 9, wherein the scenario conversion circuitry further includes:
circuitry configured to correct an action in the scenario on a basis of the personality characteristic of the human presenter which has been acquired.

11. The information presentation device according to claim 10, wherein the circuitry configured to correct an action includes:
circuitry configured to acquire a corrective action category and an action parameter reference of the action characteristic model corresponding to the personality characteristic of the human presenter that has been determined;
circuitry configured to find an action correction point in the scenario on a basis of a corrective action included in the corrective action category;
circuitry configured to compare an action parameter of the corrective action at the action correction point which has been found with the action parameter reference; and
circuitry configured to correct the corrective action having the action parameter that does not satisfy the action parameter reference such that the action parameter reference is satisfied.

12. The information presentation device according to claim 9, wherein the scenario conversion circuitry includes:
circuitry configured to add an action in the scenario on a basis of the personality characteristic of the human presenter which was determined.
